(19) United States
(12) Patent Application Publication
(10) Pub. No.: US 2017/0259648 A1
(43) Pub. Date: Sep. 14, 2017

(54) APPARATUSES AND METHODS FOR PROVIDING TRANSPORTATION CONTAINER TEMPERATURE CONTROL

(71) Applicant: Wal-Mart Stores, Inc., Bentonville, AR (US)

(72) Inventors: Sai Phaneendra Sri Harsha Viswanath Putcha, Bentonville, AR (US); Jacob C. Krause, Bentonville, AR (US)

(21) Appl. No.: 15/455,861

(22) Filed: Mar. 10, 2017

Related U.S. Application Data
(60) Provisional application No. 62/306,874, filed on Mar. 11, 2016.

(51) Int. Cl. B60H 1/32; B60H 1/00; B60P 3/20

(52) U.S. Cl. CPC B60H 1/3232; B60P 3/20; B60H 1/00792; B60H 2001/3255; B60H 2001/3266

(57) ABSTRACT

Systems, apparatuses, and methods are provided herein for providing transportation container temperature control. A system for transportation container temperature control comprises: a plurality of insulated compartments on a motored vehicle, each of the plurality of insulated compartments being configured to hold one or more items during transport, a temperature regulating system, a communication device, and a control circuit. The control circuit being configured to: receive, via the communication device, a plurality of target temperatures each associated with an insulated compartment of the plurality of insulated compartments, determine current temperatures in each of the plurality of insulated compartments, and for each insulated compartment of the plurality of insulated compartments, cause the temperature regulating system to affect a temperature inside the insulated compartment based on a current temperature and a target temperature of the plurality of target temperatures associated with the insulated compartment.

### RELATED APPLICATION

This application claims the benefit of the following U.S. Provisional Application No. 62/306,874 filed Mar. 11, 2016, which is incorporated herein by reference in its entirety.

### TECHNICAL FIELD

This invention relates generally to transport vehicles.

### BACKGROUND

Some goods, such as dairy and frozen foods, are required to be refrigerated during delivery and for storage. As such, some trucks are equipped with a refrigerated chamber for keeping goods at a controlled temperature during transport.

### BRIEF DESCRIPTION OF THE DRAWINGS

Disclosed herein are embodiments of apparatuses and methods for transportation container temperature control. This description includes drawings, wherein:

FIG. 1 is a block diagram of a system in accordance with several embodiments.

FIG. 2 is a flow diagram of a method in accordance with several embodiments.

FIGS. 3A and 3B are illustrations of a transport vehicle in accordance with several embodiments.

FIG. 4 is an illustration a transportation container in accordance with several embodiments.

FIG. 5 comprises a block diagram of a computer device in accordance with several embodiments.

Elements in the figures are illustrated for simplicity and clarity and have not necessarily been drawn to scale. For example, the dimensions and/or relative positioning of some of the elements in the figures may be exaggerated relative to other elements to help improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for transportation container temperature control. A system for transportation container temperature control comprises: a plurality of insulated compartments on a motored vehicle, each of the plurality of insulated compartments being configured to hold one or more items during transport, a temperature regulating system, a communication device, and a control circuit coupled to the communication device and the temperature regulating system. The control circuit being configured to: receive, via the communication device, a plurality of target temperatures each associated with an insulated compartment of the plurality of insulated compartments, determine current temperatures in each of the plurality of insulated compartments, and for each insulated compartment of the plurality of insulated compartments, cause the temperature regulating system to affect a temperature inside the insulated compartment based on a current temperature and a target temperature of the plurality of target temperatures associated with the insulated compartment.

For grocery deliveries, different chambers on a truck may be used to maintain different temperatures to keep groceries fresh during transport. A truck may be designed with different temperature zones that can accommodate frozen, chill, ambient, and bulk products. A truck may be divided into four different chambers with three walls made of rigid metal structures. Plastic hangings such as curtains may be used to preserve cooling in frozen and chill chambers. However, in such designs, the entire volume of each chamber is brought to the target temperature regardless of how many items are being held in the chamber. Accessing a single item would also lead to exposing the entire chamber to outside/unregulated air.

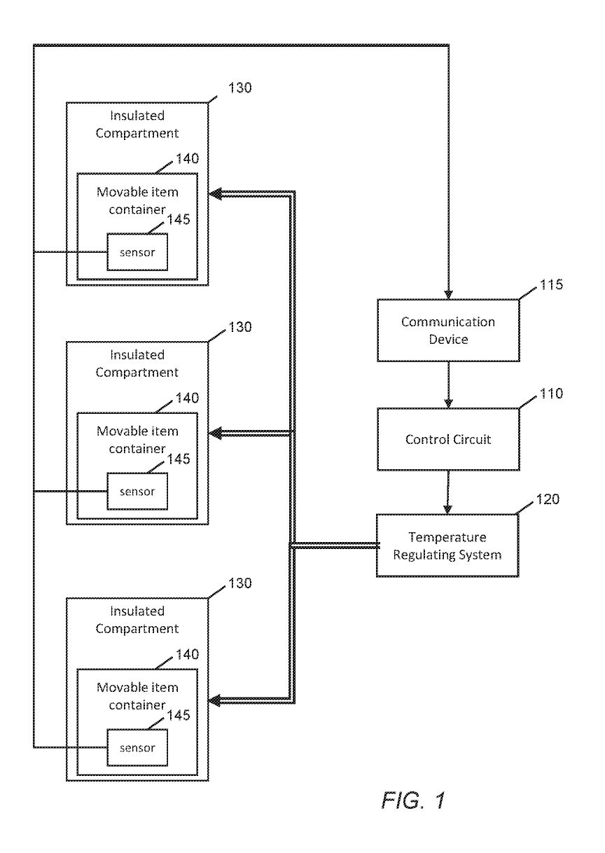

Referring now to FIG. 1, a system for transportation container temperature control according to some embodiments is shown. The system 100 includes a control circuit, a communication device, a temperature regulating system 120, and a plurality of insulated compartments 130. Each insulated compartments 130 may hold one or more movable item containers 140. In some embodiments, the system 100 may comprise a system onboard a motored vehicle such as a delivery truck, a delivery van, etc. In some embodiments, the system 100 may be integrated with or separate from one or more of the dashboard controls, the central control system, and the telemetric system of a motored vehicle.

The insulated compartments 130 may be configured to hold one or more items during transport and may comprise a transportation container of a motored vehicle. In some embodiments, a motored vehicle may comprise a plurality of rows and columns of insulated compartments 130. In some embodiments, each insulated compartment may comprise a compartment accessible from the exterior of the vehicle. For example, an associate and/or an automated unit may place and retrieve the content of the compartment without entering/climbing into a transport container portion of the motored vehicle. In some embodiments, the insulated compartment 130 may be accessible through a door and/or a roller door on a side of the vehicle. In some embodiments, the insulated compartments 130 may comprise a plurality of vertically arranged compartments accessible through a roller door. The roller door may be configured to roll up fully or partially for accessing one or more insulated compartments. In some embodiments, a transport vehicle may comprise a plurality of sets of vertically arranged insulated compartments 130. In some embodiments, one or more insulated compartments 130 may be separated from each other by removable thermal barriers such as vertical or horizontal insulating removable dividers.

The insulated compartments 130 may be coupled to a temperature regulating system 120 on the motored vehicle. In some embodiments, the temperature regulating system 120 comprises a temperature regulating device and a duct system for circulating temperature controlled air to one or more of the insulated compartments 130. In some embodiments, the temperature regulating system 120 may be configured to separately affect the temperatures inside each insulated compartments 130. For example, one or more compartments may be individually set to one of several different target temperature independent of their locations on the vehicle and their locations relative to each other. In some embodiments, the target temperatures of each compartment may be changed at any time. For example, an insulated compartment 130 may have a target temperature of 10° F. for one delivery trip and a target temperature of −5° F. for a second delivery trip. In some embodiments, the temperature regulating system 120 further comprises a plurality of vents each corresponding to at least one insulated compartment 130 that may be selectively open and close to individually control the temperatures inside the insulated compartments 130. In some embodiments, the temperature regulating system 120 comprises a vortex tube system. In some embodiments, the temperature regulating system 120 may employ one or more cooling methods comprising: vapor-compression cycle, acoustic cooling, air cycle, magnetic cooling, Malone engine, pulse tube, thermoelectric cooling, thermionic cooling, vortex tube, and water cycle systems, etc. In some embodiments, the temperature regulating system 120 may comprise one or more of a cooling and a heating system. In some embodiments, the temperature regulating system may comprise 130 a central unit for generating temperature-regulated air to circulate to insulated compartments. In some embodiments, the temperature regulating system may comprise a plurality of independent temperature control devices each configured to separately regulate the temperature in one or more insulated compartments 130.

The control circuit 110 may comprise processor-based devices such as one or more of a processor, a microprocessor, a microcontroller, and a hardwired circuitry. The control circuit 110 may be configured to control the temperature regulating system 120 to regulate the temperatures inside the insulated compartments 130. In some embodiments, the control circuit 110 may be configured to cause the temperature regulating system to affect a temperature inside the insulated compartments 130 based on a current temperature and a target temperature for each insulated compartment. In some embodiments, the insulated compartment and/or the movable item container 140 may comprise a temperature sensor for providing the current temperature inside the insulated compartment 130 to the control circuit. The temperature sensors may transmit the current temperature reading to the control circuit via wired and/or wireless data connections.

In some embodiments, the target temperature may refer to an acceptable range of temperatures for an insulated compartment 130. In some embodiments, the control circuit 110 may receive target temperatures for each insulated compartment via the communication device 115. In some embodiments, the communication device 115 may comprise a data transceiver (e.g. Wi-Fi transceiver, Bluetooth transceiver, Mobile data transceiver etc.), for communicating with a central computer system such as a remote delivery management system that manages deliveries. In some embodiments, a remote delivery management system may assign a target temperature to one or more of an insulated compartment on the motored vehicle and/or movable item containers 140 to be loaded on to the motored vehicle, and communicate the target temperatures to the control circuit 110. In some embodiments, the control circuit 110 may receive, via the communication device 115, information on a plurality of movable item container identifiers each associated a movable item container to be placed in an insulated compartment of the plurality of insulated compartments and a target temperature for the insulated compartment from the remote delivery management system. In some embodiments, the control circuit 110 may further be configured to update the remote delivery management system with the current status of one or more insulated compartments 130 (e.g. occupied, emptied, current temperature, etc.). In some embodiments, the communication device 115 may be configured to maintain wireless communication with the remote delivery management system during a delivery trip. In some embodiments, the communication device 115 may access a network at a distribution center, a store, a storage facility, etc. to download temperature control information comprising target temperature for a plurality of insulated compartments prior to a delivery trip.

In some embodiments, in place of or in addition to a data transceiver for communicating with a remote server, the communication device 115 may comprise a short range transceiver configured to communicate with a plurality of sensors 145 and/or wireless devices onboard the motored vehicle. The short range transceiver may comprise one or more of a radio frequency identification (RFID) reader, a Bluetooth transceiver, an area network transceiver, etc. The short range transceiver may communicate with one or more of sensors and/or wireless devices that are coupled to the movable item containers 140 and/or the insulated compartments 130. In some embodiments, sensors 145 on a movable item container 140 and/or an insulated compartment 130 may communicate a current temperature of the insulated compartment to the control circuit 110 via the communication device 115. In some embodiments, a wireless device (e.g. a data transceiver, a beacon device, a RFID tag, etc.) may communicate a target temperature associated with the movable item container 140 that the wireless device is attached to the control circuit 110 via the communication device 115. In some embodiments, the control circuit 110 may use the signaled received from a wireless device coupled to a movable item container 140 to determine the location of the movable item container 140. For example, the control circuit 110 may match an insulated compartment 130 to a movable item container 140 based on a signal from a wireless device. In another example, the control circuit 110 may determine whether a movable item container 140 is currently on the motored vehicle based on detecting for a signal associated with said movable item container 140 among the signals received from wireless devices in range of the motored vehicle.

The movable item container 140 may comprise any container configured to hold one or more items for delivery. In some embodiments, the movable item container 140 may comprise a box, a tote, a basket, crate etc. In some embodiments, the movable item container 140 may be delivered to a customer along with its content. In some embodiments, the movable item container may be retrieved and returned after delivery. The movable item container 140 may generally have a form factor that fits within one or more insulated compartments 130. In some embodiments, insulated compartments 130 may comprise one or more removable dividers for accommodating movable item containers 140 of different sizes. In some embodiments, the movable item container 140 may not be used and/or may comprise the packaging of an item. In some embodiments, items may be directly placed into the insulated compartments 130.

In some embodiments, the movable item container 140 may comprise a sensor 145 attached to the movable item container 140. The sensor 145 may be removable attached to and/or integrated with the movable item container 140. In some embodiments, the sensor 145 may be clipped onto the movable item container 140. In some embodiments, the sensor 145 may comprise a temperature sensor configured to measure a current environmental temperature around the movable item container 140. In some embodiments, the sensors 145 are further configured to collect information from items in the movable item container 140 and/or from customers. For example, the sensors 145 may be configured to record one or more of location, time, and temperature information throughout a delivery trip and/or after the movable item container 140 arrives a customer premises. In some embodiments, the sensor 145 may comprise part of a wireless device that is configured to wirelessly communicate with the control circuit 110 and/or a remote delivery management system. In some embodiments, the wireless device may further include a storage medium for storing information about the movable item container 140 and/or its content. The wireless device may be configured to provide the stored information to the control circuit 110 and/or a remote delivery management system. For example, the wireless device may communicate one or more of a movable item container identifier, a container content list, a target temperature, a delivery destination, etc. to the control circuit 110 via the communication device 115. In some embodiments, the wireless device may comprise a RFID tag and the insulated compartment 130 and/or the communication device may comprise an RFID reader. In some embodiments, the wireless device may comprise a control circuit and/or processor for operating one or more of the sensor 145, a storage memory, and a communication device. In some embodiments, the wireless device further comprises a power source such as a battery. In some embodiments, the wireless device may be configured to compare a measured current temperature and a stored target temperature and alert the control circuit 110 and/or a remote delivery management system if the current temperature is outside of the target temperature range.

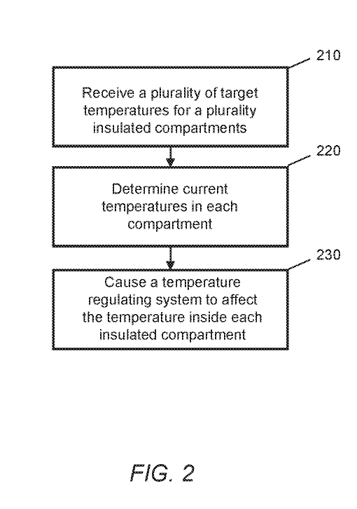

Referring now to FIG. 2, a method for transportation container temperature control according to some embodiments is shown. Generally, the method shown in FIG. 2 may be implemented with one or more processor-based devices such as devices having a control circuit, a central processor, a microprocessor, and the like. In some embodiments, the steps in FIG. 2 may be performed by one or more of a control circuit on a motored vehicle, a control circuit of a temperature regulating system, a control circuit of a central delivery management system, and/or a control circuit of a wireless device coupled to a movable item container.

In step 210, the system receives a plurality of target temperatures each associated with an insulated compartment. The insulated compartments may comprise compartments on a motored vehicle configured to hold one or more items during transport. In some embodiments, the target temperatures may be received from a remote delivery management system wirelessly communicating with the control system of a motored vehicle. The target temperatures may each be assigned to an insulated compartment of the motored vehicle based on an insulated compartment identifier and/or a movable item container identifier of a container placed in the insulated compartment. In some embodiments, the remote delivery management system may assign each movable item container to an insulated compartment and assign a target temperature to the insulated compartment based on the storage temperatures of the content of the movable item container. In some embodiments, the system may determine the target temperature of an insulated compartment based on identifying the moveable item container placed in the insulated compartment and retrieving the target temperature associated with the moveable item container.

In some embodiment, the target temperatures may be received from one or more wireless devices attached to and/or carried in movable item containers 140. For example, when movable item containers are filled and prepared, the wireless device may record a target temperature for the content of the container. The target temperature may then be transmitted from the wireless device to the control circuit of the delivery vehicle when the movable item container is loaded onto the vehicle. In some embodiments, a target temperature of a given insulated compartment can be any one of a selectable number of temperature values independent of the target temperature values of others of the plurality of insulated compartments. In some embodiment, the received target temperature may correspond to one or more of a temperature value, a temperature range, and a temperature type (e.g. frozen, cooled, room, etc.). In some embodiments, one or more insulated compartment may be configured to be assigned any one of a plurality of target temperatures at different times (e.g. for different delivery trips or segments of delivery trips).

In step 220, the system determines the current temperatures in each of the insulated compartments. In some embodiments, the current temperatures of the insulated compartments may be measured by temperature sensors coupled to each insulated compartments and/or movable item containers in the compartments. In some embodiments, the current temperatures of each insulated compartment may be individually measured by different sensors. In some embodiments, prior to step 210, the system may first detect that a movable item container is loaded or is about to be loaded onto the motored vehicle prior to proceeding from step 210 to step 220.

In step 230, the system causes a temperature regulating system to affect the temperatures inside each insulated compartment. In some embodiments, the temperatures of the insulated compartments may be regulated based on the target temperatures for each compartment received in step 210 and current temperatures of each compartment measured in step 220. In some embodiments, the temperature regulating system may comprise a duct system connecting a central temperature regulator to the insulated compartments. The duct system may be configured to circulate temperature regulated air into insulated compartments via one or more vents. In some embodiments, the system may be configured to cause the temperature regulating system to affect the temperatures inside each of the plurality of insulated compartments by selectively opening and closing vents controlling airflow to the plurality of insulated compartments. For example, if the current temperature of an insulated compartment is above the target range, the system may selectively open the vent for circulating air from the temperature regulating system to the insulated compartment to lower the temperature in the compartment. The vent may be closed when the target temperature and/or the high end of the target temperature range is reached.

In some embodiments, steps 220 and 230 may be repeated throughout a delivery trip. In some embodiments, steps 220 and 230 may be carried out periodically and separately for each insulated compartment on a motored vehicle. In some embodiments, one or more insulated compartments may not be assigned a target temperature and/or may be assigned ambient temperature as the target temperature. The temperature regulating system may then not be instructed to affect the temperature of these compartments. For example, vents to ambient temperature compartments may remain closed throughout a delivery trip.

In some embodiments, after step 230, the system may determine that a movable container has been unloaded and/or delivered. In some embodiments, the delivery vehicle may detect that a movable item container has been unloaded when a signal from a wireless device on the movable container becomes out of range. In some embodiments, a remote delivery management system may send a signal to the delivery vehicle's on-board system to indicate that a movable container has been delivered and the associated insulated compartment is now empty. In some embodiments, the unloading of movable item containers may be detected based on location information of the vehicle (e.g. global positioning system (GPS) coordinates) and designation addresses for each movable item containers. In some embodiments, the unloading of the movable item containers may be entered by a user interface such as a user interface onboard the delivery vehicle and/or a portable user device of a delivery personnel. When the system detects that a movable item container is delivered and/or is about to be delivered, the system may stop regulating the temperature inside the compartment holding the movable item container. For example, a vent to an insulated compartment may be kept closed once the compartment is emptied. In some embodiments, after the last stop on a delivery route, the central temperature regulating device of the temperature regulating system may be turned off. The process may return to step 210 when the transport vehicle is prepared for the next delivery trip.

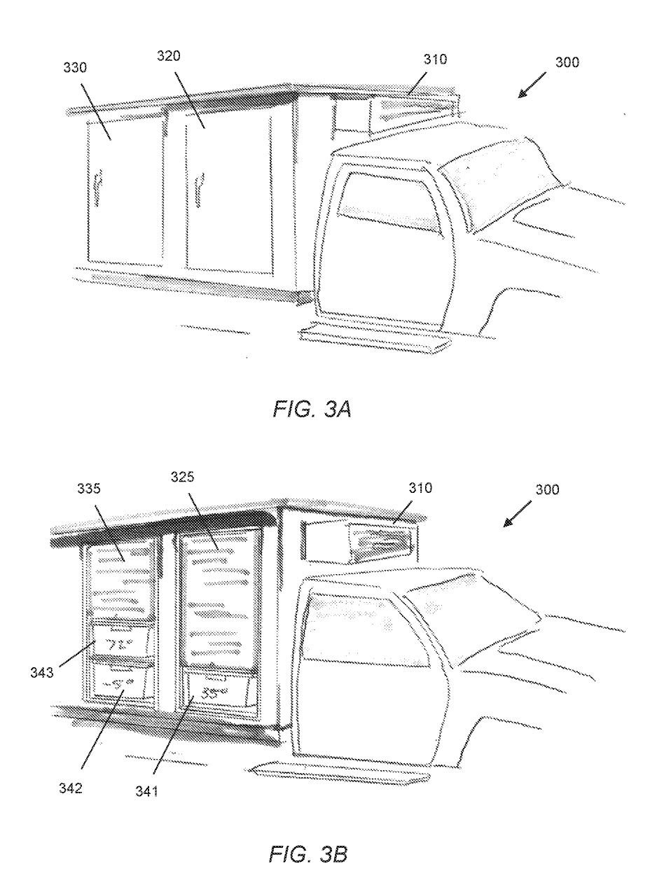

Next referring to FIGS. 3A and 3B, illustrations of a transport vehicle according to some embodiments are shown. The transport vehicle 300 may include a temperature regulating unit 310 and a plurality of doors 320 and 330 on a side of the transport vehicle 300 for accessing insulated compartments for storing items during transport. In FIG. 3A, the exterior doors 320 and 330 are closed. While the right side of the transport vehicle 300 is shown, in some embodiments, the left side and/or the back of the transport vehicle 300 may include similar exterior doors for accessing additional insulated compartments. In some embodiments, the doors 320 and 330 may comprise swing doors. In some embodiments, the doors may swing left, right, up, or down. In some embodiments, the doors 320 and 330 may comprise sliding doors. In some embodiments, the doors 320 and 330 may comprise an insulating material that provides a seal to the access opening of the insulated compartments in the transport container. In some embodiments, the storage space behind each door 320 and 330 may be referred to as a chamber, and each chamber may comprise one or more insulated compartments. In some embodiments, the housing of the transport container and/or dividers between the chambers of the transport containers may comprise one or more layers of insulating material.

In FIG. 3B, the doors 320 and 330 are opened and omitted in the illustration for simplicity and clarity. Behind the doors 330 and 320, roller doors 325 and 335 may provide additional insulation to the insulated compartments within. The roller doors 325 and 335 may be configured to roll upwards to reveal one or more insulated compartments 341, 342, and 343. For example, if insulated compartment 341 needs to be accessed, the roller door 325 may be rolled up to uncover only the insulated compartment 341 while keeping compartments above the insulated compartment 341 covered to reduce the temperature changes in the other compartments. Similarly, if the insulated compartment 343 needs to be accessed, the roller door 335 may be rolled up to uncover the insulated compartments 342 and 343. In some embodiments, the movable containers may be arranged in insulated compartments such that containers scheduled to be delivered earlier are placed in the lower insulated compartments and/or in the same column of insulated compartments. In some embodiments, the roller doors 325 and 335 may be powered and/or manually operated. For example, the roller doors 325 and 335 may include a pull tab for operating the doors. The roller doors 325 may comprise any conventional roller door and/or curtain material such as metal, plastic, heavy fabric, composite material, etc. In some embodiments, a transport container may include insulating roller doors 335 and 325 without additional exterior doors.

FIG. 3B also shows an example of each insulated compartments being regulated to have different temperatures. For example, the interior temperature of insulated compartment 343 is 72° F., the interior temperature of insulated compartment 342 is −5° F., and the interior temperature of insulated compartment 341 is 35° F. The compartments may also have different target temperatures at different times. For example, insulated compartment 343 may be assigned to have the target temperature of −5° F. or 35° F. during different delivery trips.

In some embodiments, the transport vehicle 300 may comprise any number of doors 320 and any number of insulated compartments 341, 342, and 343. The arrangements of the exterior doors and the storage compartments in FIGS. 3A and 3B are shown as an example only, and insulated compartments may be arranged on the transport vehicle in a variety of ways without departing from the spirit of the present disclosure.

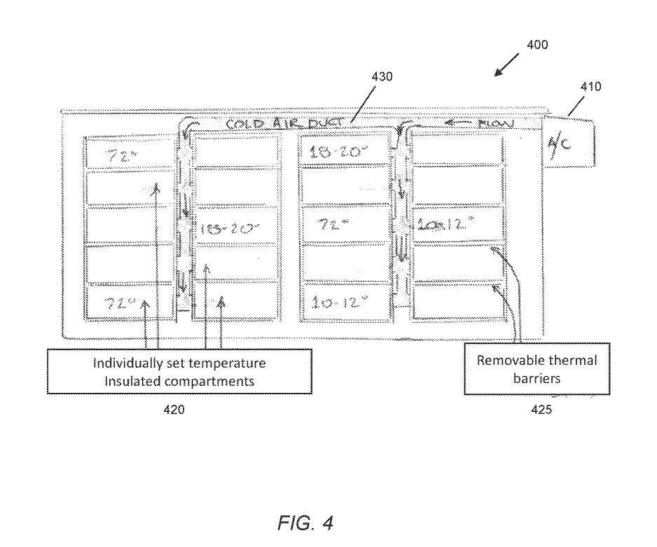

Next referring to FIG. 4, an illustration a transportation container according to some embodiments is shown. In FIG. 4, a transportation container 400 of a motored vehicle is shown. The transportation container 400 comprises a temperature regulating device 410, an air duct system 430, and a plurality of insulated compartments 420 some of which are separated by removable thermal barriers 425. The insulated compartments 420 are showed to be arranged in four columns/chambers and stacked vertically five to a column. This arrangement is shown as an example only, the insulated compartments may be arranged in a variety of configurations. The insulated compartments 420 may each be assigned with a different target temperature. For example, some of the insulated compartments are assigned the target temperature of 72° F. while others are assigned the target temperature of 8-20° F. in FIG. 4. Compartments that are not in use or are used to hold items at ambient temperature may not be regulated by the temperature regulating system. In some embodiments, the removable thermal barriers 425 may be added and/or removed from a chamber to adjust the size of one or more insulated compartments 420. In some embodiments, the removable thermal barrier 425 may comprise a horizontal or vertical sliding shelf divider.

In some embodiments, the air duct system 430 may be coupled to the temperature regulating device 410 and each of the plurality of insulated compartments 420. Cooled air may flow from the temperature regulating device 410 towards the insulated compartments 420. Each insulated compartment 420 may be coupled to a vent of the air duct system 430 to selectively allow airflow from the temperature regulating device 410 to the insulated compartments 420. The vents may be controlled by a control circuit based on the target temperatures assigned to each of the insulated compartments 420. The target temperature of a given insulated compartment may be any one of a selectable number of temperature values independent of the target temperature values of others of the plurality of insulated compartments. The target temperature assigned to an insulated compartment may also be changed anytime. In some embodiments, the columns of insulated compartments may be separated from each other by insulating dividers forming separate chambers each comprising one or more compartments. In some embodiments, the dividers may be a permanent structure of the transportation container 400 and the air duct system 430 may comprise ducts deposited within the dividers.

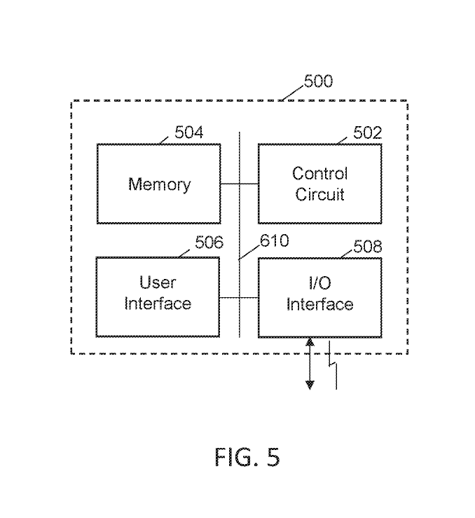

FIG. 5 illustrates a functional block diagram that may generally represent any number of various electronic components of the system for providing the transportation container temperature control that is a computer type device. The computer device 500 includes a control circuit 502, a memory 504, a user interface 506 and an input/output (I/O) interface 508 providing any type of wired and/or wireless connectivity to the computer device 500, all coupled to a communication bus 510 to allow data and signaling to pass therebetween. Generally, the control circuit 502 and the memory 504 may be referred to as a control unit. The control circuit 502, the memory 504, the user interface 506 and the I/O interface 508 may be any of the devices described herein or as understood in the art. The functionality of the computer device 500 will depend on the programming stored in the memory 504. The computer device 500 may represent a high level diagram for one or more of a server for providing transportation container temperature control, a control system onboard a motored transport vehicle, a control system of a temperature regulating system, a portable device of a driver of the motored vehicle, a central delivery management system, a wireless device attached a portable item container, or any other device or component in the system that is implemented as a computer device.

Generally, with the use of a transport vehicle with a plurality of individually temperature regulated compartments, the energy efficiency of the system may be improved. By separately regulating the temperatures of each compartment, the volume of space that is temperature regulated may be dynamically adjusted based on the load being transported. The energy loss commonly associated with items being accessed may also be reduced with the design.

In one embodiment, a system for transportation container temperature control, comprises: a plurality of insulated compartments on a motored vehicle, each of the plurality of insulated compartments being configured to hold one or more items during transport, a temperature regulating system, a communication device, and a control circuit coupled to the communication device and the temperature regulating system. The control circuit being configured to: receive, via the communication device, a plurality of target temperatures each associated with an insulated compartment of the plurality of insulated compartments, determine current temperatures in each of the plurality of insulated compartments, and for each insulated compartment of the plurality of insulated compartments, cause the temperature regulating system to affect a temperature inside the insulated compartment based on a current temperature and a target temperature of the plurality of target temperatures associated with the insulated compartment.

In one embodiment, a method for transportation container temperature control, comprises: receiving, via a communication device, a plurality of target temperatures each associated with an insulated compartment of a plurality of insulated compartments on a motored vehicle, each of the plurality of insulated compartments being configured to hold one or more items during transport, determining current temperatures in each of the plurality of insulated compartments, and for each insulated compartment of the plurality of insulated compartments, causing, with the control circuit, a temperature regulating system to affect a temperature inside the insulated compartment based on a current temperature and a target temperature of the plurality of target temperatures associated with the insulated compartment.

In one embodiment, a system for transportation container temperature control comprises: a delivery management system, a plurality of sensors coupled to item containers placed in a plurality of insulated compartments on a motored vehicle, and a control circuit on the motored vehicle. The control circuit being configured to: receive, from the delivery management system, a plurality of target temperatures each associated with an insulated compartment of the plurality of insulated compartments, receive, from the plurality of sensors, current temperatures in each of the plurality of insulated compartments, and for each insulated compartment of the plurality of insulated compartments, cause a temperature regulating system to affect a temperature inside the insulated compartment based on a current temperature and a target temperature of the plurality of target temperatures associated with the insulated compartment.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for transportation container temperature control, comprising:
a plurality of insulated compartments on a motored vehicle, each of the plurality of insulated compartments being configured to hold one or more items during transport;
a temperature regulating system;
a communication device; and
a control circuit coupled to the communication device and the temperature regulating system, the control circuit being configured to:
receive, via the communication device, a plurality of target temperatures each associated with an insulated compartment of the plurality of insulated compartments;
determine current temperatures in each of the plurality of insulated compartments; and
for each insulated compartment of the plurality of insulated compartments, cause the temperature regulating system to affect a temperature inside the insulated compartment based on a current temperature and a target temperature of the plurality of target temperatures associated with the insulated compartment.

2. The system of claim 1, wherein the current temperatures in each of the plurality of insulated compartments are determined based on temperatures detected by a plurality of sensors, one or more of which are coupled to each of movable item containers placed in the plurality of insulated compartments.

3. The system of claim 2, wherein the communication device comprising: a short range transceiver for communicating with the plurality of sensors.

4. The system of claim 2, wherein the plurality of sensors are further configured to collect information from one or more of items in a movable item container and a customer.

5. The system of claim 1, wherein the control circuit is further configured to receive, via the communication device, a plurality of movable item container identifiers each associated a movable item container to be placed in an insulated compartment of the plurality of insulated compartments and the target temperature for the insulated compartment.

6. The system of claim 1, wherein the temperature regulating system comprises a vortex tube system.

7. The system of claim 1, wherein the control circuit is configured to cause the temperature regulating system to affect the temperature inside each of the plurality of insulated compartments by selectively opening and closing vents controlling airflow to the plurality of insulated compartments.

8. The system of claim 1, wherein the plurality of insulated compartments comprises a plurality of vertically stacked compartments accessible through a roller door.

9. The system of claim 1, wherein the plurality of insulated compartments comprises compartments configured to be accessible from a side of the motored vehicle.

10. The system of claim 1, wherein the communication device is configured to communicate with a remote delivery management system.

11. The system of claim 1, wherein the target temperature of a given insulated compartment can be any one of a selectable number of temperature values independent of target temperature values of others of the plurality of insulated compartments.

12. A method for transportation container temperature control, comprising:
receiving, via a communication device, a plurality of target temperatures each associated with an insulated compartment of a plurality of insulated compartments on a motored vehicle, each of the plurality of insulated compartments being configured to hold one or more items during transport;
determining current temperatures in each of the plurality of insulated compartments; and
for each insulated compartment of the plurality of insulated compartments, causing, with a control circuit, a temperature regulating system to affect a temperature inside the insulated compartment based on a current temperature and a target temperature of the plurality of target temperatures associated with the insulated compartment.

13. The method of claim 12, wherein the current temperatures in each of the plurality of insulated compartments are determined based on temperatures detected by a plurality of sensors coupled to movable item containers placed in the plurality of insulated compartments.

14. The method of claim 13, wherein the current temperatures are received at the control circuit via a short range transceiver communicating with the plurality of sensors.

15. The method of claim 13, wherein the plurality of sensors are further configured to collect information from one or more of items in a movable item container and a customer.

16. The method of claim 12, further comprising: receiving, via the communication device, a plurality of movable item container identifiers each associated a movable item container to be placed in an insulated compartment of the plurality of insulated compartments and the target temperature for the insulated compartment.

17. The method of claim 12, wherein the temperature regulating system comprises a vortex tube system.

18. The method of claim 12, wherein causing the temperature regulating system to affect the temperature inside each of the plurality of insulated compartments comprises: selectively opening and closing vents controlling airflow to the plurality of insulated compartments.

19. The method of claim 12, wherein the plurality of insulated compartments comprises a plurality of vertically stacked compartments accessible through a roller door.

20. The method of claim 12, wherein the plurality of insulated compartments comprises compartments configured to be accessible from a side of the motored vehicle.

21. The method of claim 12, wherein the communication device is configured to communicate with a remote delivery management system.

22. The method of claim 12, wherein the target temperature of a given insulated compartment can be any one of a selectable number of temperature values independent of target temperature values of others of the plurality of insulated compartments.

23. A system for transportation container temperature control, comprising:
a delivery management system;
a plurality of sensors coupled to item containers placed in a plurality of insulated compartments on a motored vehicle; and
a control circuit on the motored vehicle, the control circuit being configured to:
receive, from the delivery management system, a plurality of target temperatures each associated with an insulated compartment of the plurality of insulated compartments;
receive, from the plurality of sensors, current temperatures in each of the plurality of insulated compartments; and
for each insulated compartment of the plurality of insulated compartments, cause a temperature regulating system to affect a temperature inside the insulated compartment based on a current temperature and a target temperature of the plurality of target temperatures associated with the insulated compartment.
